(19) United States
(12) Patent Application Publication
(10) Pub. No.: US 2005/0222936 A1
(43) Pub. Date: Oct. 6, 2005

(54) Cross-trading system

(75) Inventors: Mishel Panariti, Fair Lawn, NJ (US); Chandler Louis Paris, New York, NY (US); Akbar Ayaz, Stamford, CT (US)

Correspondence Address: DAVIDSON, DAVIDSON & KAPPEL, LLC, 485 SEVENTH AVENUE, 14TH FLOOR, NEW YORK, NY, 10018, US

(73) Assignee: Lava Trading Inc., New York, NY (US)

(21) Appl. No.: 10/814,022

(22) Filed: Mar. 31, 2004

(51) Int. Cl. G06F 17/60

(52) U.S. Cl. 705/37

(57) ABSTRACT

A system and method for cross trading of financial instruments is provided. The system and method visually displays, on a display, a plurality of unexecuted orders for a given financial instrument. The unexecuted orders include a plurality of buy orders and a plurality of sell orders, and each order includes a price per unit component and a quantity component. The system automatically identifies cross trading opportunities between one or more of the buy orders and one or more of the sell orders, and visually displays, on the display, a graphical representation of the cross trading opportunities. This graphical representation illustrates the quantity available for cross trading at each price across a price per unit range. The system accepts, from a user, a selection of a price within the price per unit range, and accepts, from the user, an execution instruction. The system then executes a cross trade at the price for the quantity associated with the price in the graphical representation, with the one or more buy orders and one or more sell orders associated with the price and quantity in the graphical representation.

### BACKGROUND INFORMATION

There are currently three primary types of computer accessible trading systems for financial instruments such as stocks, bonds, commodities, derivatives, FX (foreign exchange) and other securities. The first is the conventional stock exchange system exemplified by the New York Stock Exchange and New York Mercantile Exchange. On such exchanges the market is made for each security by a single registered stock dealer, such as a registered stock specialist, who has a seat on the exchange. In addition to face-to-face and telephone communication to the dealers/specialists on the floor, computers are used to send orders to the dealers/specialists on the exchange floor.

The second system is electronic exchanges which utilize electronic access of dealer posted market prices without a negotiating specialist or floor based exchange. The largest of these is NASDAQ. It is a totally computer-based market where each member dealer can make its own market in the stocks traded on the exchange through a computer network. Dealers trading a significant number of shares in a stock in their own name and profiting from the spread (i.e., the difference between the price which they purchase shares and the price for which they sell them) are called market makers. Market makers are most often, but not always, large financial institutions. There are usually a number of market makers in a stock, each bidding and offering stock for themselves or their customers.

The third trading system is alternative trading systems (“ATS”) which provide ATS members and electronic exchange users, such as NASDAQ users, an electronic network by which they may display and execute their orders independent of a market maker or specialist. By doing so, members avoid conventional fees while enjoying more current and complete market information. Examples of ECNs include Instinet, ARCA, BRUT, BTRD, and Island. Other ATSs include NYFIX's Millennium System.

Each member of an ECN has a trading terminal that is connected with the ECN's central order book computer. Members display their bids and offers and conduct transactions through the resulting network.

U.S. Pat. No. 6,278,982, assigned to Lava Trading Inc., describes a securities trading consolidation system where each customer uses a single trader terminal to view, and analyze security market information from and to conduct security transactions with two or more ECNs, or other comparable ATSs, alone or in combination with one or more electronic exchanges. A consolidating computer system supplies the market information and processes the transactions. The consolidating computer system aggregates order book information from each participating ECN order book computer including security, order identification, and bid/ask prices information. Bid and ask prices for participating electronic exchanges may be integrated into the display. The combined information is displayed to a customer by security and by bids and offers, and then sorted by price, volume and other available attributes as desired by the customer. The consolidating computer system forwards to each trading terminal information from only those market maker ECNs and electronic exchanges that the customer is an ECN member or electronic exchange user and thus entitled to receive.

In many cases, a customer, such as a bank or a brokerage, will have a plurality of traders, brokers, and/or broker/dealers (collectively, “traders”), and in many cases dozens of traders, each working from a respective trader terminal. For example, a bank will typically have a number of sales traders, who process orders from clients, and in some cases, execute these client orders, as well as a number of position traders, who execute client trades, as well as trades with the capital of the bank on the bank's behalf.

In other cases, the customer might consist of a single sales trader working on his/her trader terminal.

In any event, a trader will often be processing multiple overlapping orders. For example, a trader may have received an order “A” to sell 4000 shares of DELL at a limit price of $20.14 from one customer, and, at about the same time, received an order “B” to buy 2000 shares of DELL at a limit price of $20.16. Orders A and B “overlap” in that they each satisfy the other's price requirements. In any event, the trader will also typically receive market data, including NASDAQ Level II quotes, and ECN order book information from any ECNs to which the trader belongs. In such an environment, orders A and B could be executed in a number of ways: i) the orders could executed by hitting/lifting corresponding orders or quotes in the market data; ii) the orders could be sent to an ECN as limit orders, which will then appear in the ECNs order book information (unless it overlaps with some hidden liquidity on the ECN); or iii) order A could be executed directly against order B internally at the bank or brokerage.

This third option is commonly referred to as a “cross” or cross trade. When a broker has the opportunity to match a buy and a sell order internally, they can execute a cross. Such a transaction has advantages for the broker and each of the customers. For example, since the cross is generally printed (i.e. executed) between the bid and the offer, the customers receive a price improvement, and since the trade is executed internally, the broker saves on transaction fees.

Existing systems generally require traders to manually select buy and sell orders and execute the cross. Examples of such systems are disclosed in U.S. Pat. No. 6,625,583 and U.S. Pat. No. 6,539,362. In contrast, U.S. Published patent application No. 2002/0184136A1 and P.C.T. Publication No. WO 01/61547A2 purport to describe a fully automated cross-trading system.

### SUMMARY OF THE INVENTION

In accordance with an embodiment of the present invention, a system and method for cross trading of financial instruments is provided. The system visually displays, on a display, a plurality of unexecuted orders for a given financial instrument. The unexecuted orders include a plurality of buy orders and a plurality of sell orders, and each order includes a price per unit component and a quantity component. The system automatically identifies cross trading opportunities between one or more of the buy orders and one or more of the sell orders, and visually displays, on the display, a graphical representation of the cross trading opportunities. This graphical representation illustrates the quantity available for cross trading at each price across a price per unit range.

The price per unit range could be defined in a number of ways. For example, the price per unit range could be defined as at least equal to a current spread of the given financial instrument for a lesser (or greater) of a total quantity of the buy orders and a total quantity of the sell orders. The price per unit range could be set as the spread between the best bid and the best offer, inclusive of the best bid and best offer. The price per unit range could also be set to a fixed (or configurable) volume on each side (i.e. bid and offer).

In any event, the system accepts, from a user, a selection of a price within the price per unit range, and accepts, from the user, an execution instruction. The system then executes a cross trade at the price for the quantity associated with the price in the graphical representation, with the one or more buy orders and one or more sell orders associated with the price and quantity in the graphical representation. The price selection and execution instructions can be entered, for example, via a graphical user interface using a mouse, keyboard, touch screen, or other data input device.

In accordance with another aspect of this embodiment, in response to the price selection, the system preferably freezes the visual display for up to a predetermined period of time or until the execution instruction is received.

In accordance with yet another aspect of this embodiment, the step of accepting the execution instruction can include, accepting, from the user, a deselection of one or more of the orders associated with the price in the graphical representation, and thereafter accepting, from the user, the execution instruction and executing the cross trade at the price with the one or more buy orders and one or more sell orders associated with the price and quantity in the graphical representation which have not been deselected. In this manner, a user can eliminate one or more orders from the cross trade opportunity at the selected price prior to execution.

Preferably, the system can identify and execute cross trades between one buy order and one sell order, between one buy order (or sell order) and plural sell orders (or buy orders), and between plural buy orders and plural sell orders; as such cross trade opportunities arise. Moreover, the one or more buy orders and one or more sell orders preferably can include orders which have been sent to an execution venue for execution (an ECN, for example), but for which confirmation of execution has not yet been received.

In accordance with further embodiment of the present invention the display includes: a first section displaying market data for the given security, a second section displaying the graphical representation, and a third section displaying information regarding the one or more buy orders and the one or more sell orders. The information in the third section preferably includes at least the price per unit component and the quantity component, and further includes indicia indicating which of the one or more buy orders and one or more sell orders form part of the cross-trading opportunity at the selected price.

In accordance with a further aspect of the above embodiments, the graphical representation comprises an axis including indicia identifying prices within the price per unit range, and one or more bars (which may include bands or lines as described below) displayed adjacent to the axis, wherein at any given point along the axis, a size of the bar in a direction perpendicular to the axis corresponds to the quantity available for cross trading at the price associated with said given point along the axis.

In accordance with further embodiments of the present invention, computer readable media are provided, having stored thereon, computer executable process steps operative to control one or more computers to perform the steps described above.

### BRIEF DESCRIPTION OF THE DRAWINGS

FIG. 1 shows an exemplary prior art architecture in which the embodiments of the present invention can be implemented.

FIG. 2A shows an illustrative graphical user interface in accordance with an embodiment of the present invention in which a limit buy order and a limit sell order are available for a cross trade at the bid.

FIG. 2B shows the illustrative graphical user interface in accordance with an embodiment of the present invention in which a market not held buy order and a limit sell order are available for a cross.

FIG. 2C shows the illustrative graphical user interface in accordance with an embodiment of the present invention in which a market not held buy order is available for a cross with two limit buy orders.

FIG. 2D shows the illustrative graphical user interface in accordance with an embodiment of the present invention in which a market not held buy and three limit buy orders are available for a cross with three limit sell orders.

FIG. 2E shows the illustrative graphical user interface in accordance with an embodiment of the present invention in which a market not held buy and six limit buy orders are available for a cross with two market not held sell orders and two limit sell orders.

FIG. 3 is a chart which illustrates the price improvement for hypothetical cross opportunities for a buyer limit prices and seller limit prices for a security having a spread of $0.06 between a best bid of $10.0100 and a best ask (i.e., offer) of $10.0700.

FIG. 4 is a flow chart which illustrates an exemplary method for identifying cross trade opportunities in connection with the GUI of FIGS. 2A-E.

### DETAILED DESCRIPTION OF THE PREFERRED EMBODIMENTS

As described above, a trader in a bank or brokerage will typically receive orders for securities from a number of clients, and execute trades on their behalf In some cases, the trader will also have access to capital of the bank or brokerage, and may therefore also execute trades on behalf of the bank or brokerage. The trader typically executes the trade by sending an order to a trade execution entity such as an exchange or ECN. However, the trader may also execute the trade by “crossing” overlapping orders internally at the bank or brokerage.

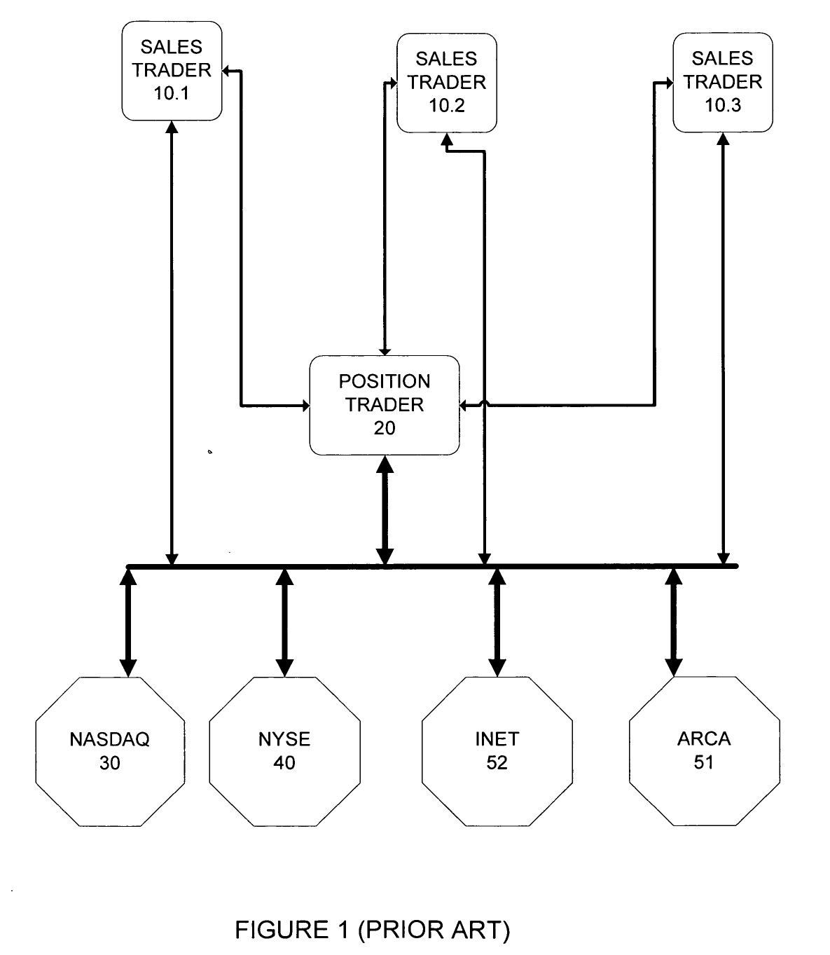

FIG. 1 illustrates a typical prior art architecture at a sell-side firm such as a bank. The firm includes a plurality of sales traders on trader terminals 10 (hereinafter “sales traders 10”) and, and preferably, a position trader on a trader terminal 20 (hereinafter “position trader 20”). The sales traders 10 receive orders from clients who wish to buy or sell stock on an exchange or ECN. In the illustration of FIG. 1, the exchanges include the NYSE 30 and NASDAQ 40, and the ECNs include Instinet 52 and Archipelago 51. Components 10, 20, 30, 40, 51, and 52 are each comprised of one or more computers and are interconnected in a conventional manner via one or more networks.

Typically, each sales trader 10 has a separate set of clients, so that a given client will generally deal with only a single trader. As such, sales trader 10.1 will have no knowledge of orders received by sales traders 10.2 or 10.3, and vice versa. After receiving an order from a client, the sales trader will either execute the trade him/herself or forward to the order to the position trader 20 for execution, depending on firm policy.

In some firms, all orders must be routed to the position trader 20. In other firms, the sales trader may be able to execute trades him/herself up to a certain number of shares, with larger volume orders being routed to the position trader. In still other firms, there may be a “head” sales trader, who receives all (or some) of the orders from each sales trader, and then executes these orders either him/herself or routes them to the position trader 20 in accordance with firm policy.

In some implementations, if the position trader is only receiving a portion of an order from a sales trader, the order will include a flag which indicates that there is additional volume for this order at the sales trader. This is sometimes referred to as a “more behind” indicator.

In any event, the position trader 20 generally executes trades not only on behalf of clients, but also on behalf of the firm. In this regard, a bank, as a source of liquidity, will generally trade on its own behalf with its own capital, as well as on behalf of its clients. Of course, this is not a characteristic unique to banks. By definition, any Broker/Dealer trades on behalf of its clients (acting as a broker) as well as on its own behalf (acting as a dealer).

Moreover, the architecture of FIG. 1, while typical, is not required. It is possible, for example, to have the sales traders execute all of their orders without involving position trader or even a head sales trader. It is also possible that all or some of the sales traders perform the functions of the position trader.

In any event, the sales traders 10 and position trader 20 in FIG. 1 execute the trades in the manner described above. For example: i) the orders could be executed by the trader hitting/lifting corresponding orders or quotes in the market data of the exchanges or ECNs; ii) the trader could send the orders to an ECN as limit orders, which will then appear in that ECN's order book information (unless it overlaps with some hidden liquidity on the ECN) for subsequent execution on the ECN; or iii) the trader could execute orders directly against his/her other orders internally at the firm in a cross-trade.

As explained above, cross-trades are generally considered the preferred execution method for a firm, because it can provide price improvement for the client, and avoids transaction fees for the firm by eliminating the need to involve an external execution entity such as an exchange or ECN.

In accordance with the present invention, an improved system and method is provided for alerting a trader to the existence of a cross-trade opportunity, and enabling the trader to efficiently and quickly execute the cross-trade. This system and method is particularly effective in enabling a trader to cross a single buy (or sell) order with multiple sell (or buy) orders, and to cross multiple buy orders with multiple sell orders.

We note that there are a variety of regulations in the United States that govern when, and how, cross-trades can be executed. In accordance with further aspects of the embodiments of the present invention, the method is optimized to enable the traders to quickly identify and execute cross-trades in a manner which is in compliance with these regulations. However, since securities regulations are often different in different jurisdictions, and, in any event, may change over time, the present invention is not limited to any particular regulatory framework.

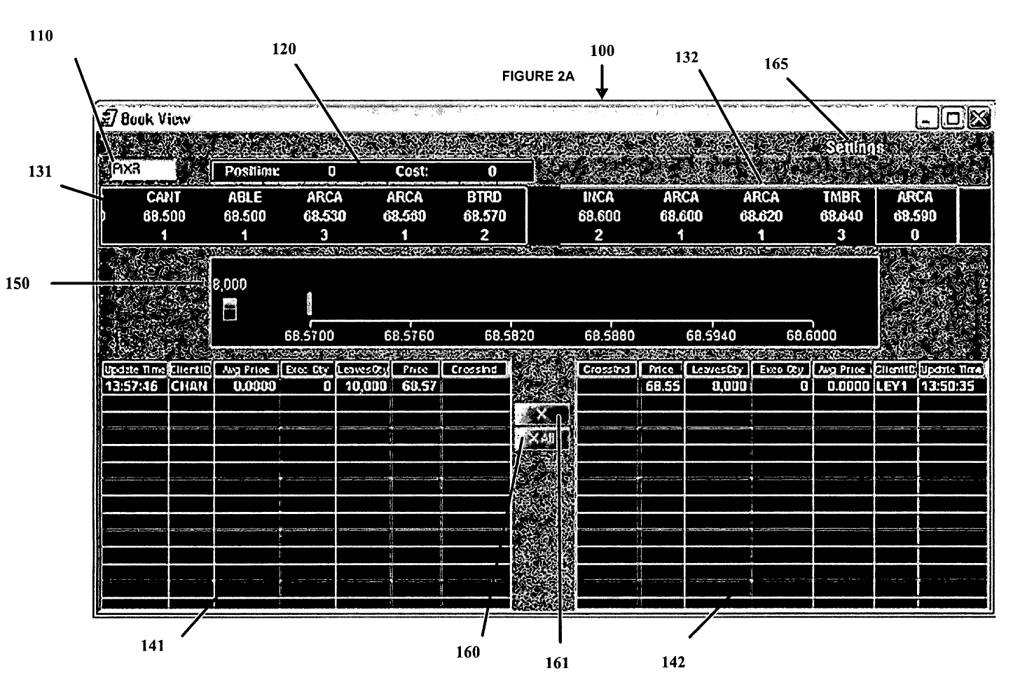

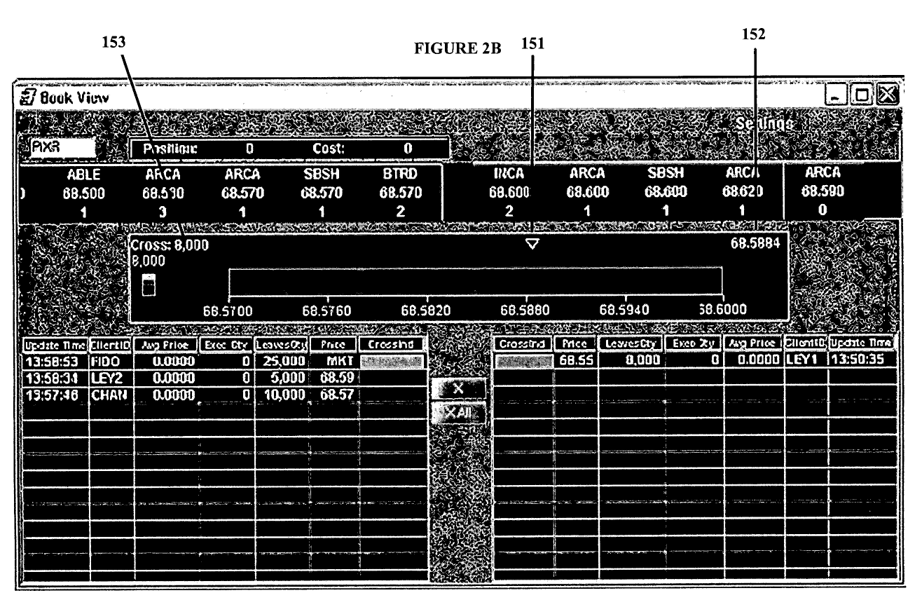

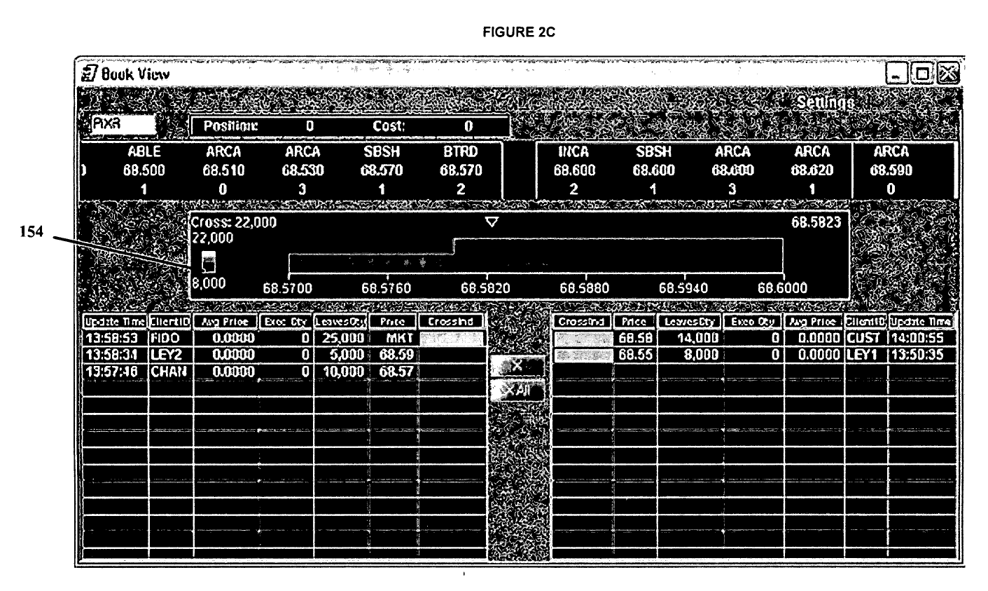

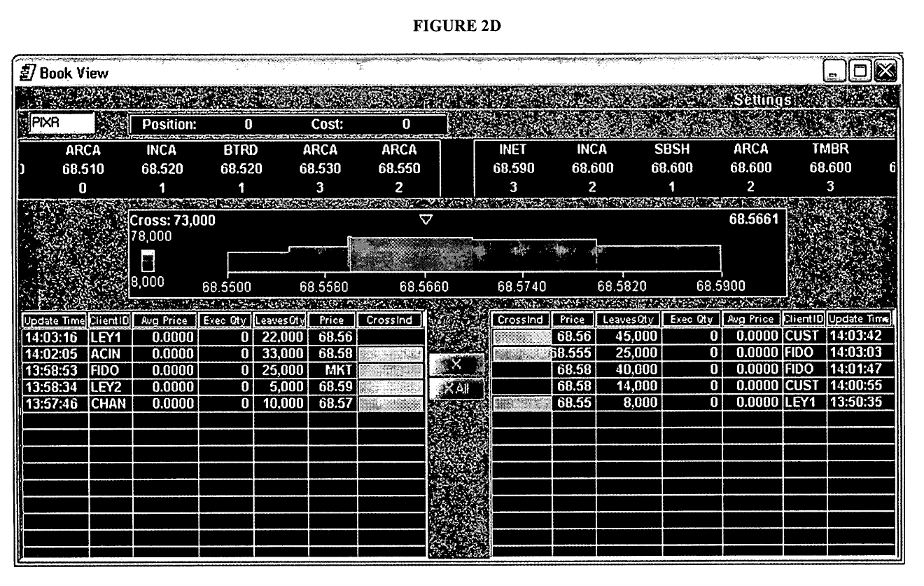

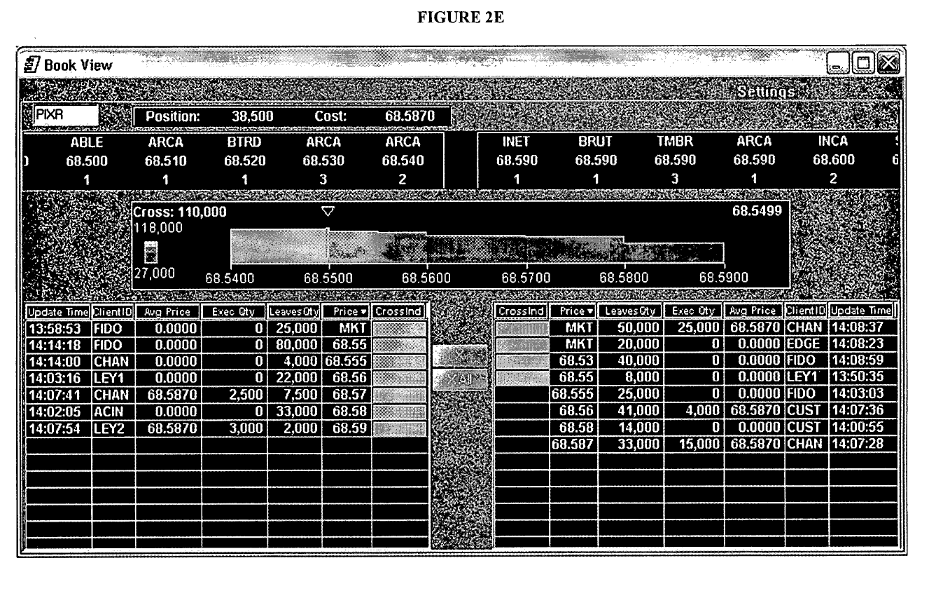

FIGS. 2A through 2E show an illustrative graphical user interface (GUI) for implementing the cross trading system in accordance with an embodiment of the present invention. Such an GUI could, for example, be implemented in the system of FIG. 1, and used by sales traders, head sales traders, and/or position traders at their respective trader terminals.

Referring to FIGS. 2A-2E, an application window 100 is shown which displays, for a given security, (i) the traders unexecuted orders, (ii) the available market data for that security, including NASDAQ Level II data, as well as data from available ECNs, and (iii) a visual cross trade indicator.

Field 110 contains the symbol for the security displayed. To change the displayed security, the user simply enters a different symbol into the field 110. In this case, the symbol entered is PIXR, the symbol for Pixar Animation Studios, and the information displayed is for that company.

The display 100 is organized with information regarding bids (orders/quotes to buy) on the left and information regarding offers (orders/quotes to sell) on the right. In this regard, Nasdaq level II bids and bids from the available ECNs are shown in panel 131 (on the left), which is implemented as a scrolling panel which scrolls through all of the bids for the displayed stock. Nasdaq Level II offers and offers from the available ECNs are similarly shown in scrolling panel 132 (on the right). Panels 131 and 132 are arranged in a mirror image, so that the highest bid is shown in the innermost position in panel 131, with lower bids extending in price order to the left, and the lowest offer is shown in the innermost position in panel 132, with higher offers extending in price order to the right. As such, the innermost bid in panel 131 ($68.570 in FIG. 2A) is the best bid in the market data (also referred to as the inside bid), and the innermost bid in panel 132 ($68.590 in FIG. 2A) is the best offer in the market data (also referred to as the inside offer). The difference between the best bid and the best offer is often referred to as the “spread”. In FIG. 2A, the spread is $0.03.

The lower portion of the display 100 includes information on the unexecuted orders that the trader has access to. Unexecuted bids are shown in panel 141 and unexecuted offers are shown in panel 142. As noted above, order access is typically governed by the firm, and can vary widely. However, taking as an example the system architecture of FIG. 1: for sales trader 10.1, panels 141 and 142 would display the unexecuted bids and offers, respectively of sales trader 10.1's clients; for sales trader 10.2, panels 141 and 142 would display the unexecuted bids and offers, respectively of sales trader 10.2's clients; for position trader 10.1, panels 141 and 142 would display the respective unexecuted bids and offers for those client orders of traders 10.1 and 10.2 that have been forwarded to the position trader 20, as well as unexecuted bids and offers which the position trader 20 is processing on the firm's behalf.

Each panel 141, 142 includes a “Cross Ind” (cross indicator) column, a “Price” column, a “Leaves Qty” column, an “Exec Qty” column, an “Avg Price” column, a “Client ID” column, and an “Update Time” column. Each unexecuted order appears on a separate row in the panel 141 or 142, with the appropriate information appearing in each respective column. The arrangement of columns in panel 141 is a mirror image of the arrangement of columns in panel 142, such that the “Cross Ind” column is the innermost column in both panels and the “Update Time” column is the outermost column in both panels. It is believed that this preferred arrangement facilitates the identification and execution of cross-trade opportunities.

Orders may be entered into the panels 141/142 in a variety of ways. For example, the orders could be entered manually by the trader through the GUI. Typically, for example, a sales trader will take orders by phone, fax, mail, or e-mail, and then manually enter the information into the GUI. Orders could also be received by fax, mail, or e-mail, and be entered by another person in the organization, at a different terminal, possibly using a different GUI. The system would then route these orders to the appropriate sales trader for processing, where they would appear in the panels 141/142 on that sales trader's GUI. Orders could alternatively be electronically transmitted to the trader by a client through a GUI available to the client, and routed to the sales trader for processing, where they would appear in the panels 141/142 on that sales trader's GUI. Orders can also be electronically transmitted to the trader via Buy-Side Customers Order routing systems or other automated Order generators, such as VWAP (“Volume Weighted Average Price”) engines. As noted above, a position trader 20 generally receives orders from the sales traders 10, which would then automatically appear in the panel 141/142 on the position traders' GUI. The position trader 20 can also enter orders manually through the GUI, or receive orders from other personnel inside or outside of the firm, depending on firm policy.

The “Price” column in the panel 141/142 is the price of the bid/offer, respectively. For example, if the order is a limit order, the “Price” column will include the limit price. If the order is a market order, the “Price” column will include an alphanumeric phrase indicative of a market order, such as “MKT”. The “Leaves Qty” and “Exec Qty” together define the total quantity of the order. In this regard, the “Exec Qty” is the number of shares which have been executed at a venue such as an exchange or ECN for execution, but for which no confirmation of execution has yet been received. In this regard, such a quantity is available for a cross-trade until the confirmation of execution is received, at which point the “Exec Qty” is updated to reflect the remaining total executed (but not confirmed) quantity of the order. The “Leaves Qty” is the number of shares in the order that have not been sent to any exchange or ECN. The “Avg Price” is the average share price of the quantity in the “Exec Qty” field. This field is of interest, because a trader would typically not wish to initiate a cross-trade on the “Exec Qty” which provides a worse price than the pending price at the exchange or ECN. The “Client ID” field includes an alphanumeric phrase identifying the client. In systems in which the position trader or head sales trader is not authorized to know the identity of the client, the Client ID field could identify the sales trader from which the order was received, or some other useful information regarding the source of the order. The “Update Time” field indicates the time that the order information was last updated.

Panel 120 displays a visual summary of the cross trade opportunities provided by the orders in panels 141 and 142. Preferably, the Panel 120 displays on a horizontal axis a price range in which the cross trade opportunity exists. The magnitude of the price range can be set on a system wide basis, or on a user-by-user basis. It can also be configurable dynamically by the user, for example, using the conventional “zoom-in” or “zoom out” functionality available in most GUIs. In FIG. 2A, the magnitude of the price range is $0.0300 per share. In this case, the axis includes price indicia every $0.0060, and the graph provides a displayed granularity (or resolution) of $0.0001.

FIG. 2A shows a limit buy order and a limit sell order available for crossing at the bid. In particular, there is a bid for 10,000 shares of PIXR with a limit price of 68.57 from client CHAN and an offer for 8,000 shares of PIXR with a limit price of 68.55 from client LEY 1. As none of these shares have been sent to an exchange or ECN, the entire share amounts are listed in the “Leaves Qty” fields of panels 140, 141, and the “Exec Qty” field is “0” in panels 140, 141. Since CHAN is willing pay as much as $68.57 per share, and LEY1 is willing to sell for as little as $68.55 per share, the orders overlap, and a crossing opportunity exists. In panel 150, a line is rendered at $68.57, the only price at which a cross trade is available. If the trader wishes to execute the cross trade, he/she simply clicks on the “X-All” button 160 or the “X” button 161, and the cross trade is “printed” (ie., executed).

The “X-All” button 160 is used when the trader wishes to execute a cross on all of the orders available for cross at any available prices. If the trader wishes to remove one or more orders from the cross (for example, in a case with multiple bids and/or multiple offers overlapping), he or she deselects the order in some predefined manner, for example, by “right clicking” on the order with a mouse, and then uses the “X” button 161 to execute the cross.

In FIG. 2B, two additional buy orders have been received for PIXR, a market not held order to buy 25,000 shares from FIDO, and a limit order to buy 5000 shares at $68.59. An order is “held” when it is subject to the regulatory requirement that the trade be executed, or sent to an execution venue, within 30 seconds. Market orders are assumed to be held unless indicated otherwise. In contrast, a limit order is assumed to be not-held, unless indicated otherwise. As such, it is common to refer to a limit order as a limit held order if it is a held order and simply as a limit order if it is not held, and to refer to a market order as a market not held order when it is not a held order, and simply as a market order when it is held. In this case, the market order to buy 25,000 shares is “not held”, meaning that the trader is free to delay execution of the order to obtain a better price. Since it is a market order, it is available for a cross anywhere from the inside bid price of $68.57 to the inside offer price of $68.600. Therefore, in FIG. 2B, there is a highlighted band extending from $68.5700 to $68.6000. Preferably, the bands, which indicate multiple crossing points, are in a different color than the lines (as in FIG. 2a), which indicate single crossing points. As used herein, the term “bar” will be used to collectively refer to bands and/or lines.

For ease of illustration, the reference numerals discussed above with regard to FIG. 2A have been omitted. Referring to FIG. 2B, the trader can select any price within that band by moving a carrot 151. In FIG. 2B, the carrot is at $68.5884, as indicated by the numeric price indicator 152 in the upper-right corner of panel 150. The number of shares available for crossing at that price is indicated in a numeric volume indicator 153 in the upper-left corner of the panel 150, indicating that 8000 shares are available for crossing. Since the cross at $68.5884 would be with the market order, the Cross ID of the market order is highlighted.

In the illustrated system, when there is only a single price crossing opportunity (i.e. represented in a line as in FIG. 2a) the GUI does not display a carrot or highlight the “Cross IND” field as this would be redundant. Of course, the GUI could be implemented to display the carrot and highlight the “Cross IND” field for single price crosses as well.

The carrot 151 can be moved freely across the price range using conventional mouse functionality, e.g., holding the left mouse button down and moving the mouse to move the carrot 151. When the trader wishes to select a particular price, he or she can indicate this by, for example, releasing the left mouse button. At this point, the display 100 “freezes” (i.e., is held stagnant) to allow the trader to decide whether to execute the trade at the selected price. Since the status of the orders and market data may change rapidly, the system preferably, sets a maximum (e.g., 15 seconds, 30 seconds, 60 seconds, or even 90 seconds) after which the display is unfrozen. In any event, in the exemplary display state of FIG. 2B, by clicking on the “X” button 161 or “X-All” button 160, the cross will be executed at $68.5884 for 8000 shares.

In FIG. 2C, a limit order has been added to sell 14,000 shares of PIXR with a limit price of $68.58 by customer CUST. As such, the market not held buy order is now available for a cross with two limit buy orders. As with the previous Figures, the available crosses are displayed in panel 150. Since the new sell limit order is at $68.58, the quantity available for the cross increases from 8,000 shares to 22,000 shares at $68.5800. This is indicated visually in panel 150 by increasing the height of the highlighted band from $68.5800 through $68.6000. Preferably, this portion of the band is a also a different color (or a different shade of the same color) from the band extending from $68.5700 through $68.5799.

Panel 150 includes a legend 154 for correlating this color change with the volume. The minimum crossable volume (8,000) is numerically indicated at the base of the legend 154, and the maximum crossable volume (22,000) is numerically indicated at the top of the legend 154. In the legend 154, different volume amounts are indicated with different colors or different shades of the same color. For example, a given color could identify the 8000 volume band, with a lighter shade of the same color (or a different color) identifying the 22,000 band. The shade (or color) sequence used by the system is replicated in the legend 154.

In the GUI illustrated in FIGS. 2A-E, the legend comprises four different shades of the same color, organized vertically from darkest to lightest, to indicate to the user that each successively lighter shade shown in the highlighted band has a higher volume. With this arrangement, it is not necessary to change the legend as the number of highlighted bands change, or to have each possible band color (or shade) represented in the legend.

In any event, in FIG. 2C, the carrot 151 has been moved by the user to $68.5823(indicated in field 152), which corresponds to a portion of the band having a volume of 22,000 (indicated in field 153). By clicking on the “X” button 161 or “X-All” button 160, a cross will be printed (i.e., executed) between the market not held buy order and the two sell limit orders for a total of 22,000 shares at $68.5823.

In FIG. 2D, two limit buy orders and three limit sell orders have been added: a buy limit order from customer ACIN for 33,000 shares at 68.58, a buy limit order from customer LEY1 for 22,000 shares at 68.56, a sell limit order from customer FIDO for 40,000 shares at 68.58, a sell limit order from customer FIDO for 25,000 shares at 68.555, and a sell limit order from customer CUST for 45,000 shares at 68.56. Panel 150 indicates that these orders have a maximum cross of 78,000 shares at $68.5590. This maximum cross would involve the seven orders which have their Cross IND field highlighted, plus client LEY1's buy order, which is not highlighted because the carrot 151 is not set to the maximum cross value. The band in panel 150 includes 6 different shades to identify the six different volumes that could potentially be crossed from a minimum volume of 8000 at $68.550 shares to a maximum volume of 78,000 shares at $68.5590. In this case, the trader has moved the carrot 151 to $68.5661, for a cross volume of 73,000. By clicking on the “X” button 161 or “X-All” button 160, a cross will be printed (i.e., executed) between the market not held buy order, three buy limit orders, and three sell limit orders for a total of 73,000 shares at $68.5661.

If desired, the user could also de-select one or more of the orders, for example, via a right-click on the mouse or other conventional functionality, and then execute the remaining selected orders at $68.5661 by clicking on the “X”button 161 as described above, or execute the original seven orders by clicking on the “X-All” button 160.

In FIG. 2E, customer FIDO has added a limit buy order for 80,000 shares with a limit price of $68.555. Customer CHAN has added a limit buy order for 4,000 shares with a limit price of $68.555. 2500 shares of customer CHAN's previous limit buy order for 10,000 shares with a limit price of $68.57 has been sent to an ECN at an average price of $68.5870, but execution has not yet been confirmed. 3000 shares of customer LEY2's previous buy limit order for 5000 shares with a limit price of $68.59 have been sent to an ECN at an average price of $68.5870, but execution has not yet been confirmed. 4000 shares of customer CUST's previous sell order for 45,000 shares with a limit price of $68.56 have been sent to an ECN at an average price of $68.5870, but execution has not yet been confirmed. Customer CHAN has added a limit sell order for 48,000 shares with a limit price of $68.587, of which 15,000 shares have been sent to an ECN at an average price of $68.5870, but execution has not yet been confirmed. Customer CHAN has also added a sell not held market order for 75,000 shares, of which 25,000 shares have been sent to an ECN at an average price of $68.5870, but execution has not yet been confirmed. Customer EDGE has added a sell not held market order for 20,000 shares.

Panel 150 indicates that these orders have a maximum cross of 118,000 shares at S68.5500. This maximum cross would involve all eleven orders which have their Cross IND field highlighted. In this case, the maximum cross does not require any of the “Exec Qty” shares. The band in panel 150 includes 7 different shades to identify the 7 different volumes that could potentially be crossed from a minimum volume of 27000 shares to a maximum volume of 118,000 shares. In this case, the trader has moved the carrot 151 to $68.5499, for a cross volume of 110,000, thereby excluding LEY1's 8000 share sell limit order at $68.55. By clicking on the “X” button 161, a cross will be executed for a total of 100,000 shares at $68.5499. The system will decide which orders participate in the cross based upon a predetermined scheme. For example, the system could give priority to older orders, to held orders, or to orders which provide the best price improvements to the customer or other entity placing the order. In the example of FIG. 2E, all of the 110,000 highlighted sell order shares will execute, but only 110,000 of the 304,500 highlighted buy order shares will participate in the cross.

Position field 120 provides the net number of shares which have been sent to exchanges or ECNs for execution but which have not yet been confirmed as executed along with the average price of these shares. In FIG. 2E, the “Exec Qty” fields for the buy orders include 5500 shares and the “Exec Qty” fields for the sell orders include 44,000 shares for a net of 38,500 sell orders as indicated in position field 120. The average price of these shares is $68.5870.

Crossing customer orders requires timely identification of the opportunity and a means to determine the size and the price of the cross. If multiple orders are present on both sides of the equation, this can become a complex calculation, and in a rapidly moving market, the time advantage can easily be lost.

Existing systems that support crossing generally require traders to manually select buy and sell orders and execute the cross. This simple method relies on the trader selecting the crossable orders, may not offer any automated pricing calculations and essentially relies on traders making the size and price decisions.

In accordance with the embodiments of the present invention described above, the system calculates and displays the cross opportunity, automatically presents the full spectrum of the crossable size and price combinations, and allows the trader to rapidly and graphically determine where the cross should take place. This system can be implemented as one or more computer executable processes, which may be resident on each trader's terminal, or located at a network server or servers, or on a distributed or peer-to-peer network.

The controls and graphics of the process, described above with regard to FIGS. 2A-E allow the trader to view the full spectrum of the size bands available for crossing and with a single screen control tool, select maximization of cross size, or select an infinitely variable price point that automatically adjust the size of the cross.

As described above, when a price point has been selected on the GUI using the carrot 151, the orders that will participate in the proposed cross are visually identified in the order panels 141, 142. Individual orders may be deselected from the cross via conventional point-and-click mouse functionality and the total quantity to participate in the cross may be reduced. For time-stamping, the process preferably “freezes” the selection for a configured amount of time (up to the regulated 90 seconds) until the execute function is selected. The freeze will capture the market data at the time of the freeze and use it in the execution.

The following algorithms are preferably used to determine when orders are available for a cross trade:
A market order to buy can be crossed with a market order to sell at any point between the bid and the offer and inclusive of the bid and offer.
A limit order to buy that is priced at the mid-point of NBBO (National Best Bid and Offer) (or inside bid/ask or best bid and offer, or current market, all of which are synonymous as used herein) can only be crossed at the mid-point with a limit order to sell at the mid-point.
Limit orders to buy and sell can be crossed at any point in the overlap of their buy and sell limit prices.
Limit orders can cross with market orders at any point between the current market, inclusive of the bid and offer (i.e. NBBO) and their limit price.

As illustrated above in connection with FIGS. 2D-E, when many orders are priced between the best bid and best offer (i.e., the spread), the crossing opportunities are numerous and the trader may wish to use his discretion to determine the best crossing price for the orders.

Although the traders can set the cross price in the manner described above with the carrot 151, the system will preferably suggest a cross price automatically. Preferably, the initial default position of the carrot 151 will be this suggested cross price, and the trader will have the opportunity to accept this price, or select his or her own price by moving the carrot 151. The following algorithm may, for example, be used to set the suggested cross price for overlapping limit orders:
If the Limit Price of the Buyer's Order is greater than or equal to the Inside Bid Price but less than the offer, the suggested cross price is the Limit Price of the Buyer's Order;
If the Price of the Seller's Order is less than or equal to the Inside Ask Price but greater than the bid, the suggested cross price is the Limit Price of the Seller's Order;
Otherwise, the suggested cross price is equal to ((the lower of the Buyer's Price and the Inside Ask Price) plus (the higher of the Seller's Price and the Inside Bid Price)) divided by 2.

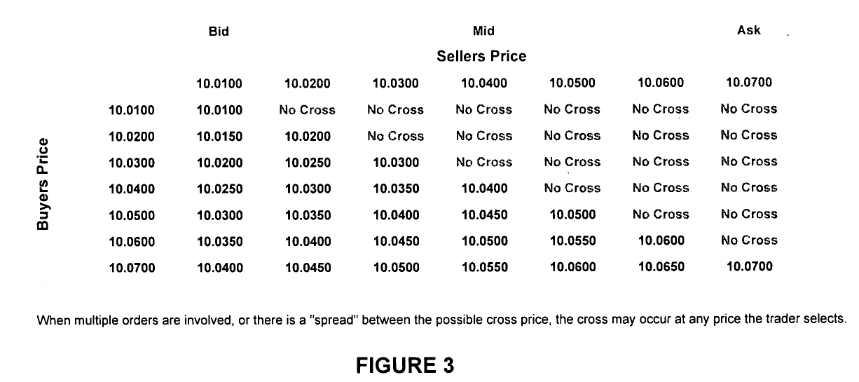

FIG. 3 is a chart which illustrates the suggested cross prices which would be generated for hypothetical buyer and seller limit prices assuming an inside bid of 10.0100 and an inside ask of 10.0700.

As noted above, the trader may over-ride this suggestion by simply moving the carrot 151 to another price. There are a variety of reasons why the trader may wish to do this. For example, he may prefer to obtain a larger volume at a slightly worse price rather than the best price for a smaller volume. His or her decision might also be affected if the same client is on both sides of the crossing opportunity (e.g., client FIDO in FIG. 2E).

In any event, as noted above, there are also a variety of regulatory considerations which may affect the eligibility of an order for a cross trade. Since such regulations may vary depending on the jurisdiction or type of security, and change over time, they will not be discussed exhaustively herein. However, it is appropriate to explain a few examples of how regulatory requirements can be taken into consideration in the cross-trading system in accordance with the present invention.

For example, under current regulations, the system is preferably configured to exclude all 144 and 144K orders, because these orders must be exposed to market risk. The system is also preferably configured to only cross agency orders with other agency orders. Principal orders are preferably eligible for crossing with other principal orders and with risk-less principal orders.

Held orders are eligible for crossing, but action should be taken within 30 seconds of order entry to comply with existing regulations. If a cross opportunity is not present (or a cross is not executed within 30 seconds), then the held order will be passed on for display through automated routing to an ECN or exchange, or automated execution at an ECN, exchange, or other execution venue.

Preferably, the crossing process should continually monitor orders which have been routed to an external source until confirmation of execution is received. External sources may include, though not limited to, the position traders quote representing the customer order in SuperMontage (i.e., the firm is acting as riskless principal), orders which have been placed on ECNs, or orders which have been routed to other broker/dealers. Processes for routing orders to external sources are described, for example, in U.S. Pat. No. 6,278,982, U.S. application Ser. No. 10/441,750 filed May 20, 2003, U.S. application Ser. No. 10/348,540, filed Jan. 21, 2003, U.S. application Ser. No. 10/762,123, filed Jan. 21, 2004, the entire disclosures of which are hereby incorporated by reference. In the preferred embodiment of FIGS. 2A-2E, such orders remain on the panels 141, 142, with the quantity and average price indicated in the Exec Qty and Avg Price fields respectively.

If the trader wishes to cross the Exec Qty, he or she selects the order as described above, and clicks on the “X” or “X-ALL” button. An order handling process will then attempt to cancel the order at the external source where it is currently being displayed or otherwise processed, wait for an affirmative determination that the routed order has been cancelled (to avoid dual liability), and then effect the cross trade in the manner described above. If the system is unable to determine that a particular routed order has been cancelled within a predetermined timeout period, then the cross trade will either be cancelled, or will be executed without that routed order (if possible), depending on the policy of the implemented system. It is also possible to make this a configurable option which can be set by the user, for example, via the settings menu 165 (FIG. 2A).

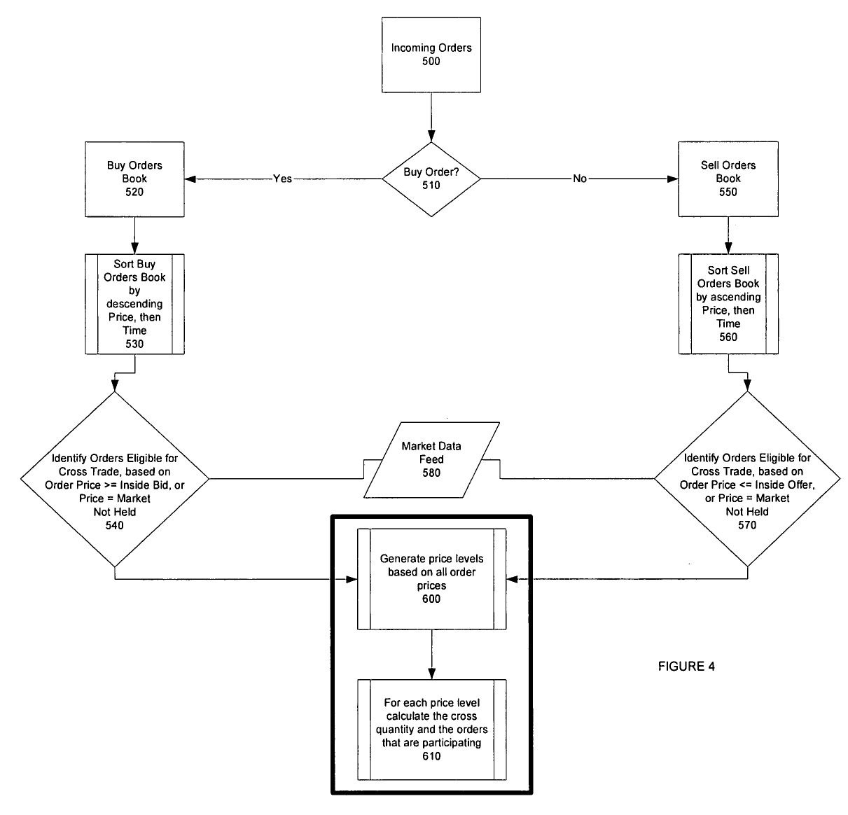

FIG. 4 is an exemplary flowchart for identifying cross trading opportunities over a price per unit range. Orders are received at step 500, as described above in connection with FIGS. 2A-E. At step 510, if a buy order is received, execution proceeds to step 520, and if a sell order is received, execution proceeds to step 550.

In any event, the active buy orders (i.e., the orders in panel 141) are sorted by descending price and then sorted by time in step 530, and the active sell orders (i.e., the orders in panel 142) are sorted by ascending price and then sorted by time in step 560. Sorting steps 530 and 560 are repeated as necessary to reflect the addition of orders, the removal of orders, and the modification of orders.

In steps 540 and 570, the active buy orders and sell orders, respectively, are analyzed to determine which orders, if any, can be considered for cross trades. This determination is made based on a predetermined algorithm as described above. In the illustration of FIG. 4, a buy order is eligible for cross trading if the order price is greater than or equal to the inside bid price (as determined from market data 580), or if the order is a market not held buy order (step 540). In contrast, a sell order is is eligible for cross trading if the order price is less than or equal to the inside offer price (as determined from market data 580)), or if the order is a market not held buy order (step 570). It should be noted that since the market data 580 changes over time, steps 540 and 570 should be performed periodically (e.g., every 5-20 seconds), because the eligibility of an order for cross trading is, in part, a function of the market data.

In any event, the buy and sell orders which are eligible for cross trading are then evaluated in steps 600 and 610. In step 600, the system generates a plurality of price levels based on the order prices and/or the market data. In other words, the system generates the prices within the price per unit range. At each of these price levels, the system calculates the total quantity available for cross trading, and the orders that would participate in the cross at that price (step 610). Steps 600 and 610 should be performed periodically (e.g., every 5-20 seconds), because the price levels and order prices are, in part, a function of the market data. The information generated in step 610 can be used to generate the information in the panel 150, and in the “Cross Ind” fields of panels 141 and 142.

In the preceding specification, the invention has been described with reference to specific exemplary embodiments and examples thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense. For example, while a carrot 151 is used to select the cross price in FIGS. 2A-E, it should be apparent that price selection could be implemented in a variety of other ways, including, for example, with a scroll bar in the GUI, with hardware such as an encoding wheel, or by moving in preset increments based on selection of a button on the GUI. Similarly, although the crossing opportunities are preferably illustrated visually with bands or bars along a horizontal axis in FIGS. 2A-E, the bars or bands could alternatively be along a vertical or even diagonal axis if desired. Moreover, other visualization techniques could alternatively be used, such as pie charts or graphs. Other modifications will be apparent to one of ordinary skill in the art as well.

1. A computerized method for cross trading of financial instruments is provided, which comprises:
visually displaying, on a display, a plurality of unexecuted orders for a given financial instrument, the unexecuted orders including a plurality of buy orders and a plurality of sell orders, each order including a price per unit component and a quantity component;
automatically identifying cross trading opportunities between one or more of the buy orders and one or more of the sell orders;
visually displaying, on the display, a graphical representation of the cross trading opportunities which illustrates the quantity available for cross trading at each price across a predetermined price per unit range;
accepting, from a user, a selection of a price within the predetermined price per unit range;
accepting, from the user, an execution instruction, and executing a cross trade at the price for the quantity associated with the price in the graphical representation, with the one or more buy orders and one or more sell orders associated with the price and quantity in the graphical representation.

2. The method of claim 1, wherein, in response to the price selection, the visual display is frozen for up to a predetermined period of time or until the execution instruction is received.

3. The method of claim 1, wherein the predetermined period of time is no more than 90 seconds.

4. The method of claim 1, wherein the predetermined period of time is no more than 30 seconds.

5. The method of claim 1, wherein the identifying step comprises automatically identifies cross trading opportunities between plural ones of the buy orders and plural ones of the sell orders, when such cross trading opportunities arise.

6. The method of claim 1, wherein the identifying step comprises automatically identifies cross trading opportunities between one of the buy orders and plural ones of the sell orders, when such cross trading opportunities arise.

7. The method of claim 1, wherein the identifying step comprises automatically identifies cross trading opportunities between ones of the sell orders and plural ones of the buy orders, when such cross trading opportunities arise.

8. The method of claim 1, wherein the identifying step comprises automatically identifies cross trading opportunities between one of the buy orders and one of the sell orders, when such cross trading opportunities arise.

9. The method of claim 1, wherein the graphical representation comprises an axis including indicia identifying prices within the price per unit range, and one or more bars displayed adjacent to the axis, wherein at any given point along the axis, a size of the bar in a direction perpendicular to the axis corresponds to the quantity available for cross trading at the price associated with said given point along the axis.

10. The method of claim 1, wherein the axis is one of a vertical axis and a horizontal axis.

11. The method of claim 1, wherein the one or more buy orders and one or more sell orders include orders which have been sent to an execution venue for execution, but for which confirmation of execution has not yet been received.

12. The method of claim 11, wherein the execution venue is an ECN.

13. The method of claim 1, wherein the step of accepting the execution instruction includes, accepting, from the user, a deselection of one or more of the orders associated with the price in the graphical representation, and thereafter accepting, from the user, the execution instruction and executing the cross trade at the price with the one or more buy orders and one or more sell orders associated with the price and quantity in the graphical representation which have not been deselected

14. The method of claim 1, wherein the display includes:
a first section displaying market data for the given security;
a second section displaying the graphical representation;
a third section displaying information regarding the one or more buy orders and the one or more sell orders, the information including at least the price per unit component and the quantity component, and further including indicia indicating which of the one or more buy orders and one or more sell orders form part of the cross-trading opportunity at the selected price.

15. A system comprising:
a sales trader process executing on a computer, the process:
visually displaying, on a display screen, a plurality of unexecuted orders for a given financial instrument, the unexecuted orders including a plurality of buy orders and a plurality of sell orders, each order including a price per unit component and a quantity component;
automatically identifying cross trading opportunities between one or more of the buy orders and one or more of the sell orders;
visually displaying, on the display screen, a graphical representation of the cross trading opportunities which illustrates the quantity available for cross trading at each price across a predetermined price per unit range;
accepting, from a user via an input device, a selection of a price within the predetermined price per unit range;
accepting, from the user via an input device, an execution instruction, and executing a cross trade at the price for the quantity associated with the price in the graphical representation, with the one or more buy orders and one or more sell orders associated with the price and quantity in the graphical representation.

16. The system of claim 15, wherein the input device is a mouse.

17. The system of claim 15, wherein the input device is a keyboard.

18. The system of claim 15, wherein the input device is a touch screen.

19. The system of claim 15, wherein the process accepts, from the user via an input device, one or more of the plurality of unexecuted orders for the given financial instrument.

20. A system comprising:
a position trader process executing on a computer, the process:
visually displaying, on a display screen, a plurality of unexecuted orders for a given financial instrument, the unexecuted orders including a plurality of buy orders and a plurality of sell orders, each order including a price per unit component and a quantity component;
automatically identifying cross trading opportunities between one or more of the buy orders and one or more of the sell orders;
visually displaying, on the display screen, a graphical representation of the cross trading opportunities which illustrates the quantity available for cross trading at each price across a predetermined price per unit range;
accepting, from a user via an input device, a selection of a price within the predetermined price per unit range;
accepting, from the user via an input device, an execution instruction, and executing a cross trade at the price for the quantity associated with the price in the graphical representation, with the one or more buy orders and one or more sell orders associated with the price and quantity in the graphical representation.

21. The system of claim 20, wherein the input device is a mouse.

22. The system of claim 20, wherein the input device is a keyboard.

23. The system of claim 20, wherein the input device is a touch screen.

24. The system of claim 20, wherein at least some of the plurality of unexecuted orders are received from a sales trader process.

25. The method of claim 1, wherein the predetermined price per unit range is at least equal to a current spread of the given financial instrument for a lesser of a total quantity of the buy orders and a total quantity of the sell orders.

26. The system of claim 15, wherein the predetermined price per unit range is at least equal to a current spread of the given financial instrument for a lesser of a total quantity of the buy orders and a total quantity of the sell orders.

27. The system of claim 20, wherein the predetermined price per unit range is at least equal to a current spread of the given financial instrument for a lesser of a total quantity of the buy orders and a total quantity of the sell orders.

28. The method of claim 1, wherein the predetermined price per unit range is configurable by the user.

29. The method of claim 1, wherein the predetermined price per unit range is at least equal to a current spread between a best bid and offer for the given security inclusive of the best bid and offer.

30. Computer readable media, having stored thereon, computer executable process steps operative to control a computer to perform steps comprising:
visually displaying, on a display, a plurality of unexecuted orders for a given financial instrument, the unexecuted orders including a plurality of buy orders and a plurality of sell orders, each order including a price per unit component and a quantity component;
automatically identifying cross trading opportunities between one or more of the buy orders and one or more of the sell orders;
visually displaying, on the display, a graphical representation of the cross trading opportunities which illustrates the quantity available for cross trading at each price across a predetermined price per unit range;
accepting, from a user, a selection of a price within the predetermined price per unit range;
accepting, from the user, an execution instruction, and executing a cross trade at the price for the quantity associated with the price in the graphical representation, with the one or more buy orders and one or more sell orders associated with the price and quantity in the graphical representation.

31. Computer readable media, having stored thereon, computer executable process steps operative to control a computer to perform steps, comprising:
visually displaying, on a display screen, a plurality of unexecuted orders for a given financial instrument, the unexecuted orders including a plurality of buy orders and a plurality of sell orders, each order including a price per unit component and a quantity component;
automatically identifying cross trading opportunities between one or more of the buy orders and one or more of the sell orders;
visually displaying, on the display screen, a graphical representation of the cross trading opportunities which illustrates the quantity available for cross trading at each price across a predetermined price per unit range;
accepting, from a user via an input device, a selection of a price within the predetermined price per unit range;
accepting, from the user via an input device, an execution instruction, and executing a cross trade at the price for the quantity associated with the price in the graphical representation, with the one or more buy orders and one or more sell orders associated with the price and quantity in the graphical representation.

32. Computer readable media, having stored thereon, computer executable process steps operative to control a computer to perform steps, comprising:
visually displaying, on a display screen, a plurality of unexecuted orders for a given financial instrument, the unexecuted orders including a plurality of buy orders and a plurality of sell orders, each order including a price per unit component and a quantity component;
automatically identifying cross trading opportunities between one or more of the buy orders and one or more of the sell orders;
visually displaying, on the display screen, a graphical representation of the cross trading opportunities which illustrates the quantity available for cross trading at each price across a predetermined price per unit range;
accepting, from a user via an input device, a selection of a price within the predetermined price per unit range;
accepting, from the user via an input device, an execution instruction, and executing a cross trade at the price for the quantity associated with the price in the graphical representation, with the one or more buy orders and one or more sell orders associated with the price and quantity in the graphical representation.
